(19) United States
(12) Patent Application Publication
(10) Pub. No.: US 2026/0098376 A1
(43) Pub. Date: Apr. 9, 2026

(54) SELF-FOLDING OR SELF-ROLLING FABRICS OR TEXTILES AND METHODS OF MAKING AND USING THE SAME

(71) Applicant: Naperie LLC, Park Ridge, IL (US)

(72) Inventor: Craig Kelliher, Park Ridge, IL (US)

(21) Appl. No.: 19/352,950

(22) Filed: Oct. 8, 2025

Related U.S. Application Data
(60) Provisional application No. 63/704,835, filed on Oct. 8, 2024.

(51) Int. Cl. D06J 1/00; F03G 7/06

(52) U.S. Cl. CPC D06J 1/00; F03G 7/06143; F03G 7/064

(57) ABSTRACT

A self-folding and/or self-rolling fabric, such as, for example, a towel or the like, comprises an internal structure of a memory material such as, for example, a metal or metal alloy wire, a metal or metal alloy foil, a polymeric material, or combinations thereof having a memory. When the memory material is heated, such as within a common heat-generating clothes dryer, the memory material reforms into a shape, thereby imparting the shape onto the fabric.

### CROSS-REFERENCE TO RELATED APPLICATIONS

The present invention claims prior to US Pat. App. No. 63/704,835, titled “Self-Folding or Self-Rolling Fabrics and Methods of Making and Using the Same,” filed October 8, 2024, which is incorporate herein by reference in its entirety.

### TECHNICAL FIELD

The present invention relates to a self-folding and/or self-rolling fabrics or textiles, such as, for example, a towel or the like. Specifically, the self-folding and/or self-rolling fabric or textile comprises an internal structure of, for example, a metal or metal alloy wire, a metal or metal alloy foil, and/or a polymeric material having a memory such that, when heated, such as within a common heat-generating clothes dryer, the internal structure forms and retains a shape, thereby imparting the shape onto the fabric or textile.

### BACKGROUND

Currently millions of people utilize paper and cloth hand towels daily to dry their hands and/or clean their house. Often, these paper and cloth towels are one-use and are thrown away after a single use. To prevent this, reusable fabrics are typically used, but these require additional steps for washing, drying and, of course, folding or rolling for reuse. However, for those currently utilizing disposable paper towels one key reason they do not transition to a reusable cloth towel is the requirement to wash and more importantly fold or roll the towels to get them ready to be utilized again.

One key problem of using reusable towels is consumers often must refold or roll the towels after they are washed and dried. This can become difficult and cumbersome, especially with a large number of reusable towels to wash, dry, and then fold or roll. In addition, elderly individuals may have difficulty manually manipulating the towels to fold and/or roll due to age-related conditions, such as arthritis and the like. Besides towels, as described herein, it may also be desired that other fabrics or textiles be folded or rolled, depending on the particular application thereof.

A need, therefore, exists for improved fabrics or textiles, such as towels, sheets, blankets, or other like fabrics or textiles. Specifically, a need exists for improved fabrics or textiles that minimize the time required to fold and/or roll them. More specifically, a need exists for improved fabrics or textiles that are reusable and are more attractive to individuals instead of using disposable alternatives.

Moreover, a need exists for improved fabrics or textiles, such as for use in towels, sheets, blankets, and other like fabrics or textiles, that may be self-folding or self-rolling. Specifically, a need exists for improved fabrics or textiles having an internal structure that imparts a shape on the fabric or textile, for example, by having a memory that may be activated forming the fabric or textile into a folded or rolled configuration. More specifically, a need exists for improved fabrics or textiles that may be configured into the folded or rolled configuration by heating the same, such as that may be accomplished during a drying cycle in a common standard clothes dryer.

### SUMMARY OF THE INVENTION

The present invention relates to a self-folding and/or self-rolling fabrics or textiles, such as, for example, a towel or the like. Specifically, the self-folding and/or self-rolling fabric or textile comprises an internal structure of, for example, a metal or metal alloy wire, a metal or metal alloy foil, and/or a polymeric material having a memory such that, when heated, such as within a common heat-generating clothes dryer, the internal structure forms and retains a shape, thereby imparting the shape onto the fabric or textile.

To this end, in an embodiment, the present invention comprises a self-foldable or self-rollable fabric or textile. The self-foldable or self-rollable fabric or textile comprises: an amount of a fabric or a textile in a planar configuration; and an internal structure within the fabric or the textile comprising a memory material configured to have a first shape, such that when formed into a second shape, retains the second shape until heated, wherein heating the memory material while in the second shape causes the internal structure to be configured into the first shape, wherein when the memory material is configured into the first shape, the fabric or the textile is in a folded or rolled configuration.

In an embodiment, the fabric or textile is in the form of a towel, a bed sheet, a pillowcase, or a blanket.

In an embodiment, the amount of fabric or textile is square or rectangular when in a flat configuration.

In an embodiment, the memory material is a metal or metal alloy wire, a metal or metal alloy foil, a polymeric material, or combinations thereof.

In an embodiment, the memory material is a nitinol wire.

In an embodiment, when the memory material is in the second shape, the fabric or textile is not in a folded or rolled configuration.

In an embodiment, the memory material returns to the first shape thereby causing the fabric or textile to be disposed in the folded or rolled configuration when the fabric or textile is heated in a conventional clothes dryer.

In an alternate embodiment of the present invention, a method of making a self-foldable or self-rollable fabric or textile is provided. The method comprises the steps of: providing an amount of fabric or textile; embedding a memory material into the fabric or textile, wherein the memory material is configured to have a first shape, such that when formed into a second shape, retains the second shape until heated, wherein heating the memory material while in the second shape causes the internal structure to be configured into the first shape, and further wherein when the memory material is configured into the first shape, the fabric or the textile is in a folded or rolled configuration.

In an embodiment, the memory material is embedded within the fabric or textile between layers of the fabric or textile.

In an embodiment, the method further comprises the steps of: providing a first layer of fabric or textile; placing the memory material adjacent the first layer of fabric or textile; and covering the memory material with a second layer of fabric or textile.

In an embodiment, the first layer and the second layer of fabric or textile are the same material.

In an embodiment, the first layer and the second layer of fabric or textile are different materials.

In an embodiment, the first layer and the second layer are fused together.

In an embodiment, the memory material is a metal or metal alloy wire, a metal or metal alloy foil, a polymeric material, or combinations thereof.

In an embodiment, the memory material forms a pattern that extends roughly across the entirety of the fabric or textile.

In an embodiment, the memory material forms a pattern within the fabric or textile.

In an alternate embodiment of the present invention, a method of using a self-foldable or self-rollable fabric or textile comprising the steps of: providing an amount of a fabric or a textile in a planar configuration having an internal structure within the fabric or the textile comprising a memory material configured to have a first shape, such that when formed into a second shape, retains the second shape until heated, wherein heating the memory material while in the second shape causes the internal structure to be configured into the first shape, wherein when the memory material is configured into the first shape, the fabric or the textile is in a folded or rolled configuration; folding or rolling the fabric or textile into a folded or rolled configuration; and heating the fabric or textile while in the folded or rolled configuration so that the memory material causes the fabric or textile to retain the folded or rolled configuration when subsequently cooled and reheated.

In an embodiment, the memory material is a metal or metal alloy wire, a metal or metal alloy foil, a polymeric material, or combinations thereof.

In an embodiment, the method further comprises the steps of: cooling the fabric or textile; and forming the fabric or textile into a second shaped configuration.

In an embodiment, the method further comprises the step of: reheating fabric or textile so that the fabric or textile reforms into the folded or rolled configuration.

It is, therefore, an advantage and objective of the present invention to provide improved fabrics or textiles, such as towels, sheets, blankets, or other like fabrics or textiles.

Specifically, it is an advantage and objective of the present invention to provide improved fabrics or textiles that minimize the time required to fold and/or roll them.

More specifically, it is an advantage and objective of the present invention to provide improved fabrics or textiles that are reusable and are more attractive to individuals instead of using disposable alternatives.

Moreover, it is an advantage and objective of the present invention to provide improved fabrics or textiles, such as towels, sheets, blankets, and other like fabrics or textiles, that may be self-folding or self-rolling.

Specifically, it is an advantage and objective of the present invention to provide improved fabrics or textiles having an internal structure that imparts a shape on the fabric or textile, for example, by having a memory that may be activated forming the fabric or textile into a folded or rolled configuration.

More specifically, it is an advantage and objective of the present invention to provide improved fabrics or textiles that may be configured into the folded or rolled configuration by heating the same, such as that may be accomplished during a drying cycle in a common standard clothes dryer.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a fabric or textile containing therein or thereon a memory material in an embodiment of the present invention.

FIG. 2 illustrates an alternate fabric or textile containing therein or thereon a memory material in an alternate embodiment of the present invention.

FIGS. 3A-3B illustrate an alternate fabric or textile containing therein or thereon a memory material in alternate embodiments of the present invention.

FIG. 4 illustrates an alternate fabric or textile containing therein or thereon a memory material in yet another alternate embodiment of the present invention.

### DETAILED DESCRIPTION OF THE PRESENTLY PREFERRED EMBODIMENTS

The present invention relates to a self-folding and/or self-rolling fabrics or textiles, such as, for example, a towel or the like. Specifically, the self-folding and/or self-rolling fabric or textile comprises an internal structure of, for example, a metal or metal alloy wire, a metal or metal alloy foil, and/or a polymeric material having a memory such that, when heated, such as within a common heat-generating clothes dryer, the internal structure forms and retains a shape, thereby imparting the shape onto the fabric or textile.

In an embodiment, the present invention comprises a self-foldable or self-rollable fabric or textile. The self-foldable or self-rollable fabric or textile comprises: an amount of a fabric or a textile in a planar configuration; and an internal structure within the fabric or the textile comprising a memory material configured to have a first shape, such that when formed into a second shape, retains the second shape until heated, wherein heating the memory material while in the second shape causes the internal structure to be configured into the first shape, wherein when the memory material is configured into the first shape, the fabric or the textile is in a folded or rolled configuration.

For example, the memory material may comprise a metal or a metal alloy wire, a metal or metal alloy foil, a polymeric material, or combinations thereof that may be incorporated into a fabric or textile, such as, for example, a towel, a bedsheet, a pillow case, a blanket, and/or any other like fabric or textile as may be apparent to one of ordinary skill in the art. The metal or metal alloy wire or foil and/or polymeric material may be embedded into the fabric or textile as an internal structure thereof. Alternatively, the metal or metal alloy wire or foil and/or polymer material may be embedded between two or more layers of the same or different fabric materials, thereby forming an internal structure to the two or more layers thereof when the two or more layers are fused together. The memory metal alloy, such as nitinol wire, may be incorporated therein or thereon in the following manners, either alone or in combination: sewn, knitted, adhered with adhesives, disposed between layers, or otherwise incorporated within or on the cloth or fabric, as apparent to one of ordinary skill in the art.

A preferred metal alloy wire or foil is commonly known as “nitinol,” which is a metal alloy comprising nickel and titanium. For example, nitinol may comprise about 55% nickel and about 45% titanium in one embodiment, although the particular amounts of nickel and titanium may vary. Different memory properties may require different nitinol alloys and the present invention should not be limited as described herein. Nitinol and other memory materials work via what is known as a “two-way shape memory effect.” This shape memory effect occurs when the memory material, such as nitinol, undergoes a reversible phase transformation between the Austenite crystalline and Martensite crystalline phases. The atoms of metals are generally arranged in specific structures, depending on their components, but rarely change structure shape while still solid.

Under elevated temperatures, nitinol may enter the Austenite crystalline phase. In this phase, the nitinol may achieve maximum stiffness and is spring-like when bent. However, when cooled, nitinol enters the Martensite crystalline phase. In this phase, nitinol feels rubbery and may bend easily. When nitinol is in its Martensitic crystalline form, it can easily deform into a new shape. However, when heated through its transformation temperature, it reverts back to its Austenite crystalline phase and recovers its previous shape. Slight changes in the composition of nitinol, such as the percentages of nickel and titanium, may influence the temperature at which the metal alloy enters the crystalline phases.

Therefore, in the present invention, the fabric or textile, such as, for example, the towel, may comprise the memory material, such as nitinol, embedded therein. A first shape, such as a folded or rolled shape, may be imparted to the nitinol by folding and/or rolling the fabric. The fabric and, by extension, the nitinol embedded as an internal structure therein, may be heated to a specific temperature so that the nitinol embedded therein enters its Austenite crystalline phase. Upon cooling, and after the nitinol enters its Martensitic crystalline phase, the fabric may be formed into any shape and used.

When in the form of a towel for example, the fabric or textile may be used as towels are traditionally used, such as for drying hands or other objects, and/or for cleaning purposes. The fabric containing the nitinol therein may be washed in a conventional washing machine or washed via any other method and dried at an elevated temperature. After washing, the towel may be dried in a conventional clothes dryer. The temperature of the clothes dryer may be set so as to allow the nitinol within the fabric to re-enter the Austenite crystalline phase, which may allow the nitinol embedded within the towel to retain its first shape. As the nitinol retains its first shape, it may impart the first shape to the towel, thereby re-forming the folded or rolled configuration.

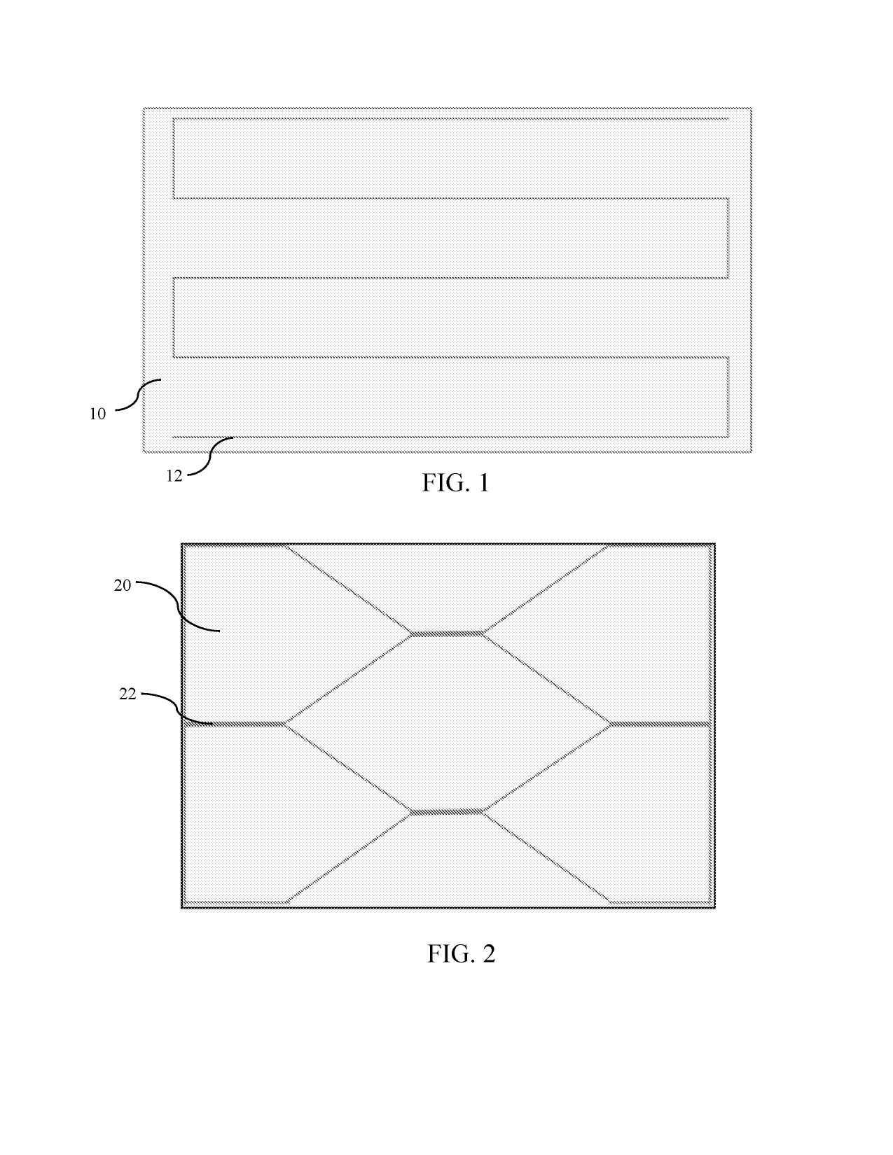

FIG. 1 illustrates an exemplary embodiment of the present invention of a fabric or textile 10 having a planar configuration, wherein the cloth or fabric is rollable, foldable, or otherwise flexible to be manipulated into a folded or rolled configuration. Disposed within or on the fabric or textile may be a memory material 12, such as a metal or metal alloy wire, a metal or metal alloy foil, and/or a polymeric material, such as, for example, nitinol wire. The memory material 12 may be a metal wire, a metal or metal alloy foil, and/or a polymer material set in an internal structure, namely a back-and-forth configuration from one side of the cloth or fabric to the other and from a top of the cloth or fabric to the bottom of the cloth or fabric, as shown in FIG. 1. Thus, the internal structure of the memory material may extend roughly throughout the entirety of the fabric or textile.

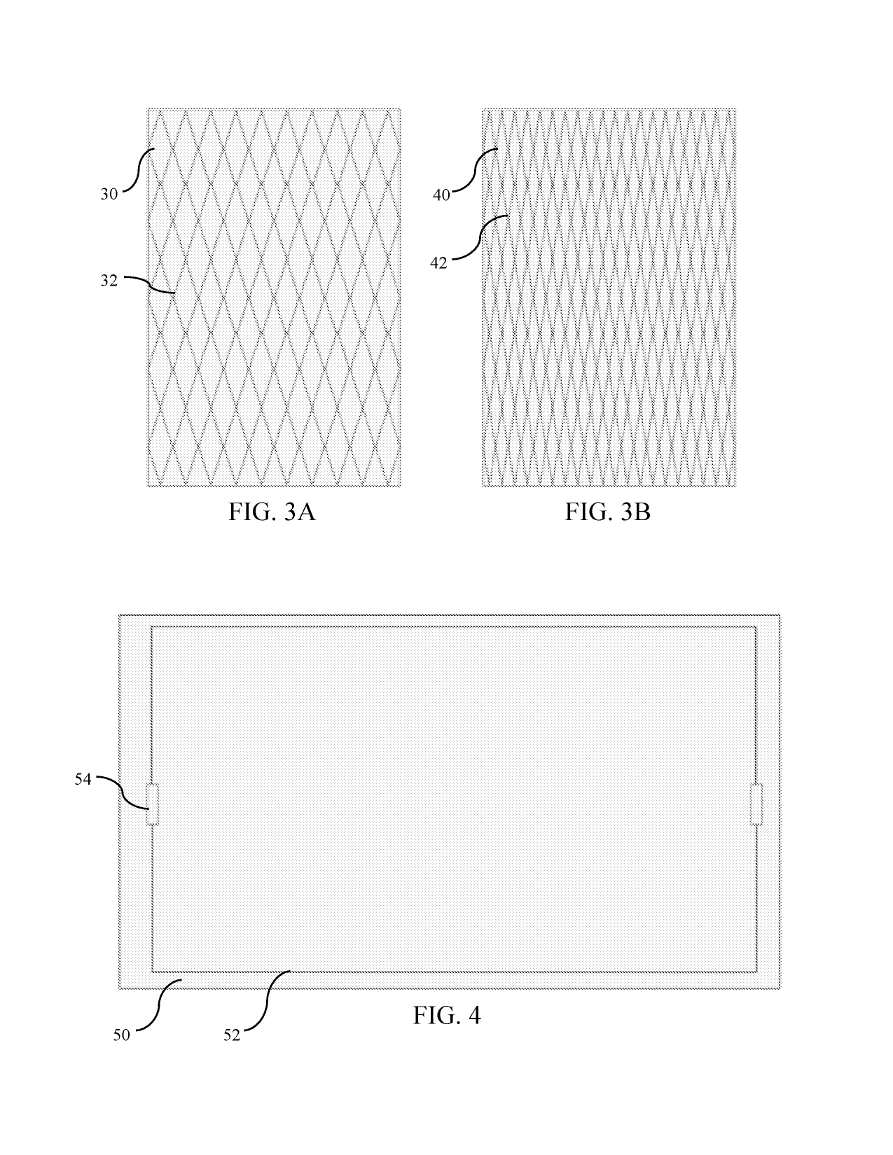

Other patterns for disposing the memory material, such as the metal or metal alloy wire, the metal or metal alloy foil, and/or the polymeric material, therein or thereon may be implemented to arrive at similar results and the present invention should not be limited as described herein. For example, FIG. 2 illustrates a fabric or textile 20 comprising a memory material 22 in a modified large diamond configuration, thereby ensuring that the metal material 22 is distributed through the fabric or textile 20. Likewise, FIGS. 3A and 3B illustrate alternate patterns of memory material, namely showing a fabric or textile 30 having a memory material 32 in a tight diamond configuration, as shown in FIG. 3A, and a fabric or textile 40 having a memory material 42 in a tighter diamond configuration, as shown in FIG. 3B. FIG. 4 illustrate an alternate embodiment of a fabric or textile 50 having a memory material 52 forming a frame at or near a perimeter of the fabric or textile 50 and further having crimps or connections 54 for disposing parts of the memory material together.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

What is claimed is:

1. A self-foldable or self-rollable fabric or textile comprising:
an amount of a fabric or a textile in a planar configuration; and
an internal structure within the fabric or the textile comprising a memory material configured to have a first shape, such that when formed into a second shape, retains the second shape until heated, wherein heating the memory material while in the second shape causes the internal structure to be configured into the first shape,
wherein when the memory material is configured into the first shape, the fabric or the textile is in a folded or rolled configuration.

2. The self-foldable or self-rollable fabric or textile of claim 1 wherein the fabric or textile is in the form of a towel, a bedsheet, a pillowcase, or a blanket.

3. The self-foldable or self-rollable fabric or textile or claim 1 wherein the amount of fabric or textile is square or rectangular when in a flat configuration.

4. The self-foldable or self-rollable fabric or textile of claim 1 wherein the memory material is a metal or metal alloy wire, a metal or metal alloy foil, a polymeric material, or combinations thereof.

5. The self-foldable or self-rollable fabric or textile of claim 1 wherein the memory material is a nitinol wire.

6. The self-foldable or self-rollable fabric or textile of claim 1 wherein when the memory material is in the second shape, the fabric or textile is not in a folded or rolled configuration.

7. The self-foldable or self-rollable fabric or textile of claim 1 wherein the memory material returns to the first shape thereby causing the fabric or textile to be disposed in the folded or rolled configuration when the fabric or textile is heated in a conventional clothes dryer.

8. A method of making a self-foldable or self-rollable fabric or textile comprising the steps of:
providing an amount of fabric or textile;
embedding a memory material into the fabric or textile, wherein the memory material is configured to have a first shape, such that when formed into a second shape, retains the second shape until heated, wherein heating the memory material while in the second shape causes the internal structure to be configured into the first shape, and further wherein when the memory material is configured into the first shape, the fabric or the textile is in a folded or rolled configuration.

9. The method of claim 8 wherein the memory material is embedded within the fabric or textile between layers of the fabric or textile.

10. The method of claim 8 further comprising the steps of:
providing a first layer of fabric or textile;
placing the memory material adjacent the first layer of fabric or textile; and
covering the memory material with a second layer of fabric or textile.

11. The method of claim 10 wherein the first layer and the second layer of fabric or textile are the same material.

12. The method of claim 10 wherein the first layer and the second layer of fabric or textile are different materials.

13. The method of claim 10 wherein the first layer and the second layer are fused together.

14. The method of claim 8 wherein the memory material is a metal or metal alloy wire, a metal or metal alloy foil, a polymeric material, or combinations thereof.

15. The method of claim 8 wherein the memory material forms a pattern that extends roughly across the entirety of the fabric or textile.

16. The method of claim 9 wherein the memory material forms a pattern within the fabric or textile.

17. A method of using a self-foldable or self-rollable fabric or textile comprising the steps of:
providing an amount of a fabric or a textile in a planar configuration having an internal structure within the fabric or the textile comprising a memory material configured to have a first shape, such that when formed into a second shape, retains the second shape until heated, wherein heating the memory material while in the second shape causes the internal structure to be configured into the first shape, wherein when the memory material is configured into the first shape, the fabric or the textile is in a folded or rolled configuration;
folding or rolling the fabric or textile into a folded or rolled configuration; and
heating the fabric or textile while in the folded or rolled configuration so that the memory material causes the fabric or textile to retain the folded or rolled configuration when subsequently cooled and reheated.

18. The method of claim 17 wherein the memory material is a metal or metal alloy wire, a metal or metal alloy foil, a polymeric material, or combinations thereof.

19. The method of claim 17 further comprising the steps of:
cooling the fabric or textile; and
forming the fabric or textile into a second shaped configuration.

20. The method of claim 19 further comprising the step of:
reheating fabric or textile so that the fabric or textile reforms into the folded or rolled configuration.
